(19) United States
(12) Patent Application Publication
(10) Pub. No.: US 2026/0061998 A1
(43) Pub. Date: Mar. 5, 2026

(54) VEHICLE CONTROL DEVICE AND EXTERNAL DEVICE CONFIGURED TO TRANSMIT AND RECEIVE INFORMATION TO AND FROM VEHICLE CONTROL DEVICE

(71) Applicant: TOYOTA JIDOSHA KABUSHIKI KAISHA, Toyota-shi (JP)

(72) Inventor: Satoshi NAKAMURA, Nagoya-shi (JP)

(73) Assignee: TOYOTA JIDOSHA KABUSHIKI KAISHA, Toyota-shi (JP)

(21) Appl. No.: 19/213,361

(22) Filed: May 20, 2025

(30) Foreign Application Priority Data
Aug. 27, 2024 (JP) 2024-145549

(51) Int. Cl. B60W 30/09; B60W 30/095; B60W 30/18; B60W 60/00

(52) U.S. Cl. CPC B60W 30/09; B60W 30/0956; B60W 30/18154; B60W 30/18159; B60W 60/0015; B60W 2555/60; B60W 2556/45

(57) ABSTRACT

A vehicle control device includes a controller configured to perform assist control for avoiding a collision between a vehicle and an object when the vehicle and the object meet a collision determination condition. The controller is configured to change the collision determination condition from a normal condition to an easy-to-meet condition when the vehicle has entered an intersection with a traffic light while the traffic light ahead of the vehicle is either yellow or red, or when information is acquired that indicates that the vehicle is highly likely to enter an intersection with a traffic light when the traffic light ahead of the vehicle is either yellow or red. The easy-to-meet condition is a condition that is more easily met than the normal condition.

### CROSS-REFERENCE TO RELATED APPLICATION

This application claims priority to Japanese Patent Application No. 2024-145549 filed on Aug. 27, 2024. The disclosure of the above-identified application, including the specification, drawings, and claims, is incorporated by reference herein in its entirety.

### BACKGROUND

### 1. Technical Field

The present disclosure relates to a vehicle control device configured to perform driver assist control for collision avoidance (collision damage mitigation) at an intersection with a traffic light, and an external device configured to transmit and receive information to and from the vehicle control device.

### 2. Description of Related Art

Conventionally, there have been known systems in which an autonomous driving management device (autonomous driving kit (ADK)) and a vehicle travel control device cooperate to control a vehicle to travel along a target trajectory generated by the autonomous driving management device. In one of such systems, the vehicle travel control device performs travel assist control for safer driving (see, for example, Japanese Unexamined Patent Application Publication No. 2023-92024 (JP 2023-92024 A)).

### SUMMARY

Since autonomous driving management devices are developed by various manufacturers, autonomous driving characteristics provided by such devices vary from device to device. One autonomous driving management device autonomously drives a vehicle such that the vehicle passes through an intersection with a traffic light even through the traffic light is yellow or red. This occurs when autonomous driving control is mature and a vehicle is equipped with an autonomous driving management device configured to autonomously drive a vehicle such that sudden braking, sudden starts, etc. do not occur. Even when a driver manually drives a vehicle instead of an autonomous driving management device, some drivers may proceed into an intersection with a traffic light when the traffic light is yellow or red. It is desired to make driver assist control for collision avoidance function more effectively for driving of a vehicle at an intersection with a traffic light.

The present disclosure provides a vehicle control device that can make driver assist control for collision avoidance function more effectively when a vehicle passes through an intersection with a traffic light.

A vehicle control device according to an aspect of the present disclosure includes a controller (10) configured to perform assist control for avoiding a collision between a vehicle and an object when the vehicle and the object meet a collision determination condition.

The controller is further configured to

change the collision determination condition from a normal condition to an easy-to-meet condition (S340, S570) when the vehicle has entered an intersection with a traffic light while the traffic light ahead of the vehicle is either yellow or red (S330: Yes), or when information is acquired that indicates that the vehicle is highly likely to enter an intersection with a traffic light when the traffic light ahead of the vehicle is either yellow or red (S560, S565: Yes). The easy-to-meet condition is a condition that is more easily met than the normal condition.

According to this aspect, the collision determination condition is changed from the normal condition to the easy-to-meet condition when the vehicle has entered an intersection with a traffic light while the traffic light ahead of the vehicle is either yellow or red. The easy-to-meet condition is, for example, a condition that is met for an object located at a position farther away from the vehicle in the direction of travel of the vehicle or at a position farther away in a lateral direction relative to the direction of travel of the vehicle than in the normal condition. Alternatively, the easy-to-meet condition is, for example, a condition that is met when the time to collision, namely the time remaining until the vehicle reaches the object, has decreased to a longer threshold time than in the normal condition (that is, a condition that is met earlier than the normal condition). As a result, the above aspect can further improve the safety of the vehicle when the vehicle passes through an intersection with a traffic light (that is, an intersection where a traffic light is installed).

In the aspect of the disclosure,

the controller may be configured to
autonomously drive the vehicle according to an instruction from an autonomous driving kit mounted on the vehicle.

Since the autonomous driving kit controls the vehicle to travel based on predetermined logic, driving characteristics of the autonomous driving kit are less likely to change. That is, one autonomous driving kit may control the vehicle to enter an intersection with a traffic light when the traffic light ahead of the vehicle is either yellow or red. In this case, this autonomous driving kit is highly likely to drive the vehicle in the same way at other intersections with a traffic light. Therefore, the above aspect can stably improve the safety of the vehicle that is automatically driven by the autonomous driving kit, and at the same time, can reduce the possibility that the driver may feel uneasy due to the assist control for collision avoidance being activated excessively.

In the aspect of the disclosure,

the controller may be configured to
transmit first driving characteristic data to an external device (server SV) when the vehicle has entered an intersection with a traffic light while the traffic light ahead of the vehicle is either yellow or red (S520), and
transmit second driving characteristic data to the external device when the vehicle has entered an intersection with a traffic light while the traffic light ahead of the vehicle is green (S525).

In the above aspect, the controller may be configured to acquire driving characteristic information from the external device (server SV) by communication (S560). The driving characteristic information is information acquired by the external device based on the first driving characteristic data and the second driving characteristic data and indicating a driving characteristic of the autonomous driving kit.

The driving characteristic information may include first information and second information. The first information is information indicating that the vehicle is highly likely to enter an intersection with a traffic light when the traffic light is either yellow or red, and the second information is information indicating that the vehicle is highly likely to enter an intersection with a traffic light when the traffic light is green. The second information can also be said to be information indicating that the vehicle is unlikely to enter an intersection with a traffic light when the traffic light is either yellow or red.

According to this aspect, when the controller receives the first information, it can be determined that the vehicle is highly likely to enter an intersection with a traffic light when the traffic light ahead of the vehicle is either yellow or red.

In the above description, in order to facilitate understanding of the present disclosure, names and/or signs used in the following embodiments are added in parentheses to the configurations of the disclosure corresponding to those of the embodiments. However, the components of the present disclosure are not limited to those of the embodiments defined by the names and/or signs. The present disclosure also encompasses an external device configured to transmit and receive information to and from the controller, a method for controlling driving of a vehicle, and a program thereof.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device according to a first embodiment of the present disclosure;

FIG. 2A is a plan view illustrating “normal condition and easy-to-meet condition” which is a collision determination condition;

FIG. 2B is a plan view illustrating “normal condition and easy-to-meet condition” which is a collision determination condition;

FIG. 3 is a routine that is executed by a CPU of a vehicle control ECU shown in FIG. 1;

FIG. 4 is a routine that is executed by the CPU of the vehicle control ECU shown in FIG. 1;

FIG. 5 is a routine that is executed by the CPU of the vehicle control ECU according to a second embodiment of the present disclosure; and

FIG. 6 is a routine that is executed by a server according to a modification of the present disclosure.

### DETAILED DESCRIPTION OF EMBODIMENTS

### First Embodiment

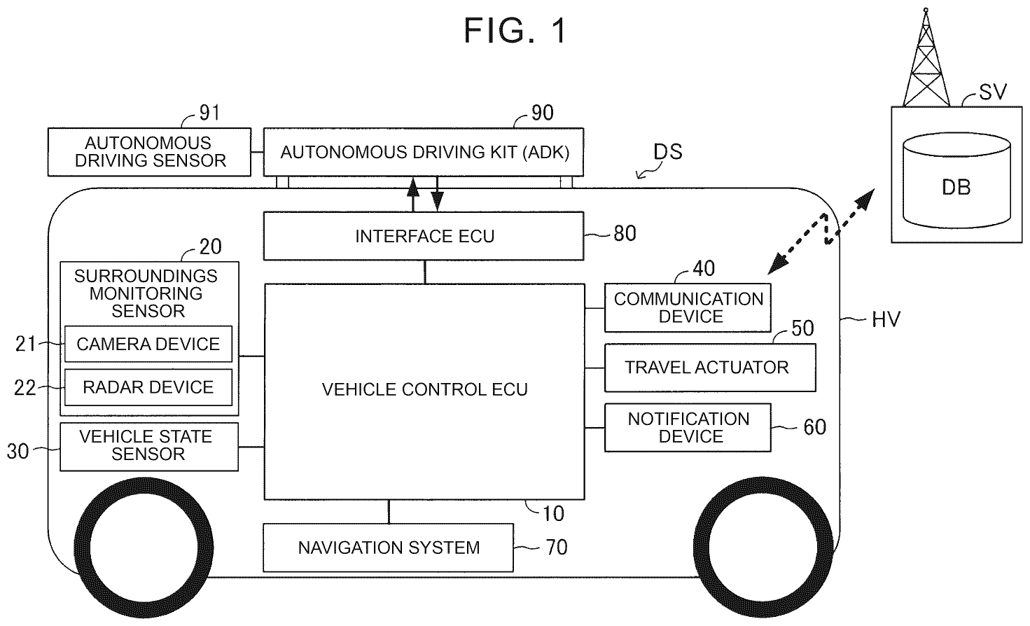

A vehicle control device DS according to the first embodiment of the present disclosure (hereinafter, referred to as “first device DS”) includes components illustrated in FIG. 1, and is applied to (mounted on) a vehicle HV. The vehicle HV may be any of a vehicle using an internal combustion engine as a power source, a battery electric vehicle, a hybrid electric vehicle, and the like.

In the present specification, an Electronic Control Unit (ECU) is an electronic control device including, as a main device, a microcomputer including a CPU (processor), a ROM, RAM, a data-writable nonvolatile memory, and the like. The ECU is also referred to as a controller or a computer. The plurality of ECUs shown in FIG. 1 is connected to each other through a Controller Area Network (CAN) so that they can transmit and receive information to and from each other. The plurality of ECUs shown in FIG. 1 may be integrated into one ECU. One ECU shown in FIG. 1 may be realized by a plurality of ECUs.

The vehicle control ECU 10 performs collision avoidance control for avoiding collision of the vehicle HV with the object. The collision avoidance control is one of the driver assist controls, and is also referred to as collision damage mitigation control. The vehicle control ECU 10 is connected to the surroundings monitoring sensor 20, the vehicle state sensor 30, the communication device 40, the travel actuator 50, the notification device 60, the navigation system 70, and the interface ECU 80 via a CAN or directly.

The surroundings monitoring sensor 20 includes a camera device 21 and a radar device 22.

The camera device 21 captures an image of the surroundings of the vehicle by a camera, and thereby acquires image data. The camera device 21 generates camera information by analyzing the image data, and transmits the camera information to the vehicle control ECU 10.

The camera information includes division line information such as a position of a division line of a lane on which the vehicle HV is traveling and a type of division line, and traffic light information including a color of a traffic light ahead of the vehicle. In addition, the camera information includes camera object information such as “location, relative longitudinal speed, and relative lateral speed” of the captured object with respect to the vehicle HV and the type of the object.

The radar device 22 is a well-known device that acquires information about an object existing around the vehicle HV using radio waves in a millimeter-wave band. The radar device 22 acquires radar information based on the information about the transmitted and received millimeter waves, and transmits the radar information to the vehicle control ECU 10. The radar information includes the distance from the vehicle HV to the object, the “azimuth and relative velocity” of the object with respect to the vehicle HV, and the type of the object.

The vehicle control ECU 10 integrates the camera object information and the radar information to generate fusion object information. The vehicle control ECU 10 performs collision-avoidance control based on the fusion object data.

The vehicle state sensor 30 includes, for example, a “sensor, a switch, and the like” described below.
An accelerator pedal operation amount sensor that detects an accelerator pedal operation amount AP.
A brake pedal operation amount sensor that detects a brake pedal operation amount BP.
A vehicle speed sensor that detects a speed (that is, host vehicle speed) Vh of the vehicle HV.
A steering angle sensor for detecting a steering angle SA of the vehicle HV.

The communication device 40 communicates with a vehicle control ECU 10 and an external device (for example, a server of a traffic information center) SV. The vehicle control ECU 10 can acquire various types of information from the external device SV via the communication device 40.

The travel actuator 50 includes a powertrain actuator that controls a power source of the vehicle HV, a brake actuator that controls a braking device of the vehicle HV, and a steering actuator that controls a steering system of the vehicle HV. The vehicle control ECU 10 can change the traveling condition of the vehicle HV by transmitting an instruction to the travel actuator 50. That is, the vehicle control ECU 10 changes the driving force applied to the vehicle HV, the braking force applied to the vehicle HV, and the steering angle of the vehicle HV by using the travel actuator 50.

The notification device 60 includes a warning display device and a warning sound generation device. In response to an instruction from the vehicle control ECU 10, the notification device 60 can cause the warning display device to display a warning image and cause the warning sound generation device to generate a warning sound. Display of a warning image and generation of a warning sound are also one of driver assist controls.

The navigation system 70 includes a GPS receiver, a map information storage device storing map information, and a display touch panel. The navigation system 70 acquires the current location of the vehicle HV based on GPS received by GPS receiver. The map information includes information on the location of the intersection and on whether the intersection has a traffic light.

The interface ECU 80 is a communication interface between the vehicle control ECU 10 and an autonomous driving kit 90 described later.

The autonomous driving kit 90 is a device that provides driving instruction information to a vehicle control ECU 10 in order to autonomously drive a vehicle HV from a predetermined departure point to a predetermined destination point. The autonomous driving kit 90 is also referred to as “ADK” and is manufactured by a plurality of manufacturers. The autonomous driving kit 90 is configured to receive data from an autonomous driving sensor (vehicle surroundings sensor) 91 including LiDAR.

The external device SV includes a communication device, a storage device DB for storing data, and servers. The external device SV is hereinafter simply referred to as “server SV”. The server SV can transmit and receive information described later to and from the communication device 40 via a network and wireless communication. The server SV is installed in, for example, a traffic information center.

### Overview of Operation

The autonomous driving kit 90 provides the vehicle HV with driving characteristics that are different from manufacturer to manufacturer. For example, one autonomous driving kit 90 controls the vehicle HV to enter the intersection when a traffic light ahead the vehicle HV turns yellow or red and the vehicle HV will not be able to stop before the intersection unless a certain amount of sudden braking is performed. For example, another autonomous driving kit 90 controls the vehicle HV to perform some degree of sudden braking to stop before the intersection, when a traffic light ahead of the vehicle HV turns yellow or red.

The first device DS starts an operation for collision avoidance (for example, automatic braking) when a predetermined collision determination condition is met. The first device DS changes the collision determination condition from the “normal condition” to the “easy-to-meet condition” when the vehicle HV has entered an intersection with a traffic light while the traffic light ahead of the vehicle HV is yellow or red. The easy-to-meet condition is a condition that is more easily met than the normal condition. In other words, the collision risk in the case where the easy-to-meet condition is met is lower than the collision risk in the case where the normal condition is met.

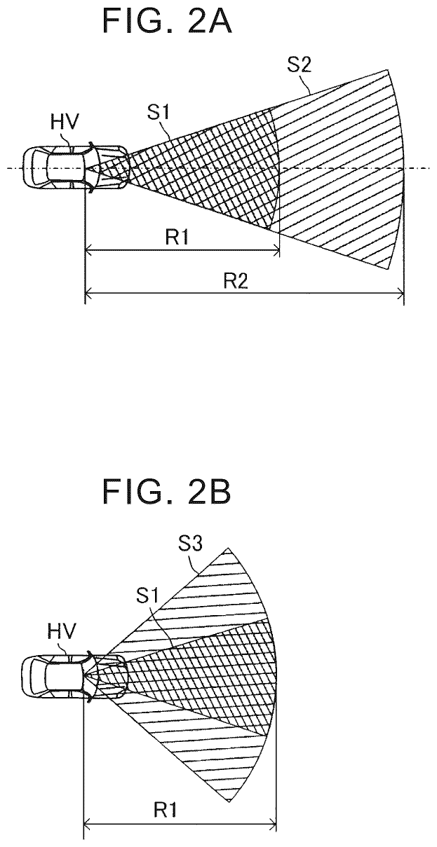

For example, as shown in FIGS. 2A and 2B, the normal condition is a condition that is met when the object is located in the first region S1 ahead of the vehicle HV. The first region S1 has a fan shape, and the center line thereof is a straight line passing through the center of the upper end of the front windshield of the vehicle HV and extending in the front-rear direction of the vehicle HV. The radius (length of the center line) R1 of the first region S1 increases as the host vehicle speed Vh or the relative velocity of an object located ahead of the vehicle HV in the direction in which the object approaches the vehicle increases.

For example, as shown in FIG. 2A, the easy-to-meet condition is a condition that is met when the object is located in the second region S2 ahead of the vehicle HV. The second region S2 has a fan shape with the same central angle as the first region S1, and the center line thereof is a straight line passing through the center portion of the upper end of the front windshield of the vehicle HV and extending in the front-rear direction of the vehicle HV. The radius (length of the center line) R2 of the second region S2 is longer than the radius R1, and increases as the host vehicle speed Vh or the relative velocity of the object located ahead of the vehicle HV in the direction in which the object approaches the vehicle increases. Since the second region S2 has a larger radius than the first region S1, the easy-to-meet condition is also met when the object is located at a location farther from the vehicle HV than the normal condition.

Further, for example, as illustrated in 2B, the easy-to-meet condition is a condition that is met when the object is located in the third region S3 ahead of the vehicle HV. The third region S3 has a fan shape, and the center line thereof is a straight line passing through the center of the upper end of the front windshield of the vehicle HV and extending in the front-rear direction of the vehicle HV. The radius (length of the center line) R3 of the third region S3 is the same as the radius R1, and increases as the host vehicle speed Vh or the relative velocity of the object located ahead of the vehicle HV in the direction in which the object approaches the vehicle increases. The central angle of the third region S3 is larger than the central angle of the first region S1. Therefore, the easy-to-meet condition is also met when the object is located at a location further to the right or left in the traveling direction of the vehicle HV than the normal condition.

The first device DS may be calculated by dividing the distance between the object and the vehicle HV by the relative velocity in the direction approaching the vehicle HV of the object, by the time to collision TTC until the object and the vehicle HV collide with each other. Then, the first device DS may determine that the collision determination condition is met when the time to collision TTC becomes equal to or less than the collision determination threshold TTCth. In this case, the first device DS sets the collision determination condition in which the collision determination threshold TTCth is set to the first value Tth1 as the normal condition. Further, the first device DS sets the collision determination condition in which the collision determination threshold TTCth is set to the “second value Tth2 that is longer than the first value Tth1” as the easy-to-meet condition. The collision determination condition is also referred to as a condition for performing the collision avoidance assist operation.

As a result, when the autonomous driving kit 90 mounted on the vehicle HV has the “driving characteristic that tends to allow the vehicle HV to enter an intersection with a traffic light when the traffic light is yellow or red”, the collision avoidance assist operation is easily performed. Therefore, safer autonomous driving can be implemented.

### Specific Operation

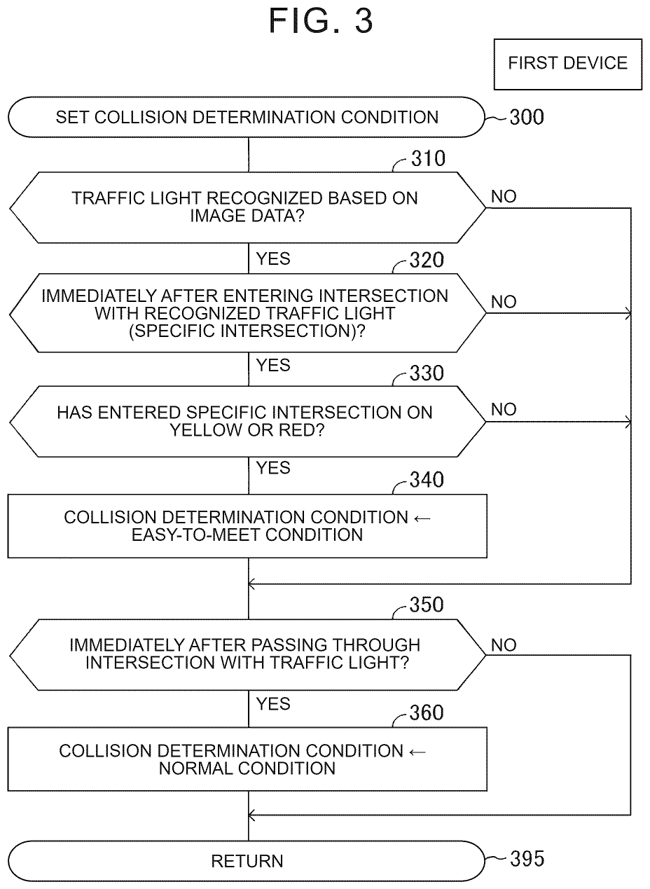

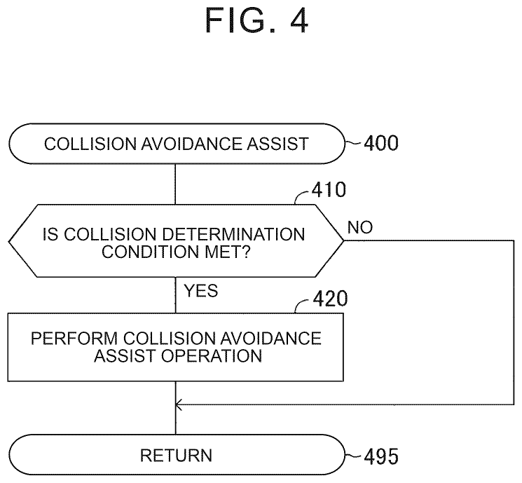

The CPU of the vehicle control ECU 10 (hereinafter, simply referred to as “CPU”) executes the routines illustrated by the flow charts in FIGS. 3 and 4 every predetermined period (calculation cycle). Hereinafter, the “step” is referred to as “S”.

### Change of Collision Determination Condition

When the appropriate time comes, the CPU starts the process from S300 of FIG. 3 and proceeds to S310. In S310, the CPU determines whether the traffic light is currently recognized based on the traffic light information acquired from the image data.

When the traffic light is recognized, the CPU proceeds from S310 to S320 and determines whether the current time is immediately after the vehicle HV entered an “intersection where the recognized traffic light is installed”. The intersection where the recognized traffic light is installed will be referred to as a specific intersection.

The current time may be immediately after the vehicle HV entered a specific intersection. The CPU then proceeds from S320 to S330. Then, the CPU determines whether the vehicle HV has entered the specific intersection while the traffic light at the specific intersection is yellow or red, based on the image data, the current location of the vehicle HV, and the map information.

When the vehicle HV has entered the specific intersection while the traffic light at the specific intersection is yellow or red, the CPU proceeds from S330 to S340 and changes the collision determination condition from the normal condition to the easy-to-meet condition. When the vehicle HV is activated, the collision determination condition is set to a normal condition. The CPU then proceeds to S350.

On the other hand, when the CPU determines “No” in any of S310, S320 and S330, it proceeds directly from the step determined as “No” to S350.

In S350, the CPU determines whether the current time is immediately after the vehicle HV passed through the intersection with a traffic light, based on the map information and the current location of the vehicle HV.

When the current time is immediately after the vehicle HV passed through the “intersection where the traffic light is installed”, the CPU proceeds from S350 to S360. In S360, the CPU sets the collision determination condition to the normal condition regardless of whether the collision determination condition is the easy-to-meet condition or the normal condition. The CPU then proceeds to S395 to tentatively terminate the routine. On the other hand, when the current time is not immediately after the vehicle HV passed through the “intersection where the traffic light is installed”, the CPU proceeds directly from S350 to S395.

### Collision Avoidance Operation

When an appropriate time comes, the CPU starts the process from S400 of FIG. 4 and proceeds to S410 to determine whether the collision determination condition is met. As described above, the collision determination condition is set to either the normal condition or the easy-to-meet condition.

When the collision determination condition is met, the CPU proceeds from S410 to S420, and performs automatic braking as the collision avoidance assist operation. In the automatic braking, a braking force is applied to the vehicle HV to stop the vehicle HV such that it does not collide with the object. At this time, the CPU may perform an operation of displaying a warning image on the warning display device and/or an operation of generating a warning sound on the warning sound generation device. The CPU then proceeds to S495 to tentatively terminate the routine. On the other hand, when the collision determination condition is not met, the CPU proceeds directly from S410 to S495.

As described above, the first device DS changes the collision determination condition from the normal condition to the easy-to-meet condition when the vehicle HV has entered an intersection with a traffic light while the traffic light ahead of the vehicle HV is either yellow or red. Therefore, the first device DS can further improve the safety of the vehicle HV when the vehicle HV passes through an intersection with a traffic light.

### Second Embodiment

The vehicle control device according to the second embodiment of the present disclosure (hereinafter, referred to as “second device”) accumulates, in the server SV, driving characteristic data of the autonomous driving kit 90 when the vehicle HV passes through an intersection with a traffic light. The server SV obtains information (i.e., driving characteristic information) representing the driving characteristics of each autonomous driving kit 90 based on the driving characteristic data, and holds the driving characteristic information. When the vehicle HV approaches an intersection with a traffic light, the second device acquires the driving characteristic information of the autonomous driving kit 90 mounted on the vehicle HV from the server SV, and changes the collision determination condition based on the driving characteristic information.

### Transmission of Driving Characteristic Data to Server

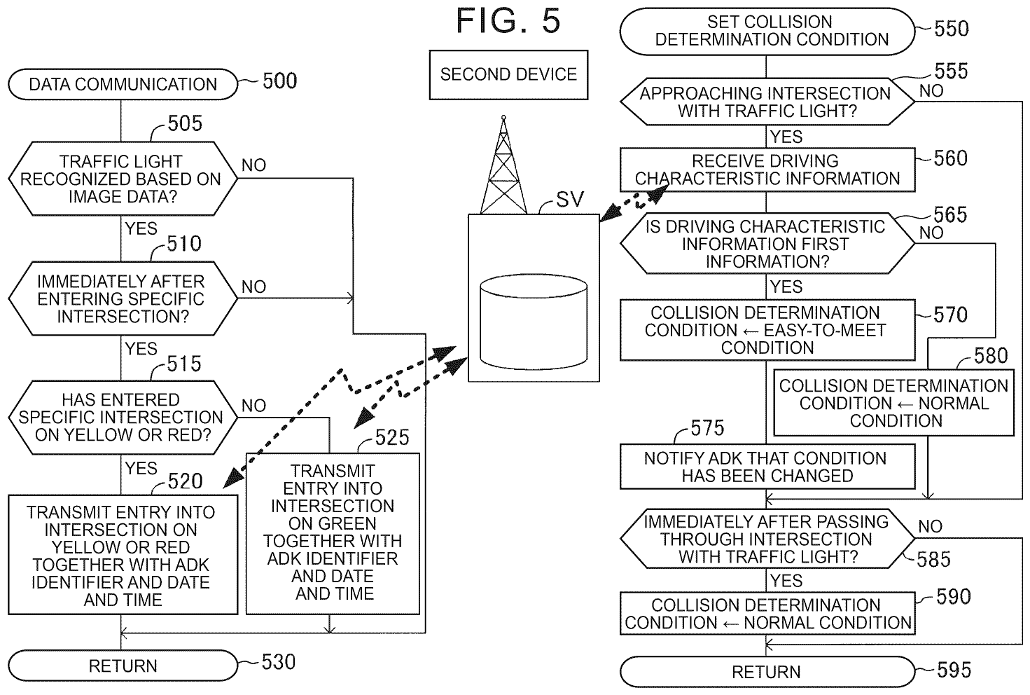

When an appropriate time comes, the CPU starts the process from S500 of FIG. 5 and proceeds to S505 to make the same determination as in S310. When the determination condition in S505 is met, the CPU proceeds to S510 and performs the same determination as S320. When the determination condition in S510 is met, the CPU proceeds to S515 and performs the same determination as S330. When either S505 or S510 is not met, the CPU proceeds directly to S530 and terminates the routine tentatively.

The determination condition in S515 is met when the vehicle HV has entered an intersection with a traffic light while the traffic light ahead of the vehicle HV is either yellow or red. In this case, the CPU proceeds to S520, and transmits, as the driving characteristic data, information indicating that the vehicle HV has entered the intersection while the traffic light is yellow or red, together with the identifier of the autonomous driving kit 90 and the date and time of the entry into the intersection, to the server SV. The identifier of the autonomous driving kit 90 includes the model (product number), manufacturer, and version of software for the autonomous driving kit 90. The information that is transmitted to the server SV in S520 is also referred to as “first driving characteristic data” for convenience. The CPU then proceeds to S530 to tentatively terminate the routine.

On the other hand, S515 determination criteria may not be met. The CPU then proceeds from S515 to S525. The CPU transmits, as the driving characteristic data, information indicating that the vehicle HV has entered the intersection while the traffic light is green, together with the identifier of the autonomous driving kit and the date and time of the entry into the intersection, to the server SV. The information that is transmitted to the server SV in S525 is also referred to as “second driving characteristic data” for convenience. The CPU then proceeds to S530. Such a process is performed for each vehicle HV equipped with the autonomous driving kit 90 and the second device.

The server SV stores, for each identifier of the autonomous driving kit 90, the driving characteristic data transmitted as a result of S520 or S525 in a database. The server SV acquires the driving characteristic information of the autonomous driving kits 90 based on the driving characteristic data and holds the acquired driving characteristic data in the database. For example, the server SV obtains the ratio RA of the “total number of pieces of driving characteristic data indicating that the vehicle HV has entered an intersection while a traffic light is yellow or red” to the “total number of pieces of driving characteristic data” for one autonomous driving kit 90. That is, the ratio RA is the ratio of the “number of pieces of first driving characteristic data” to the “sum of the number of pieces of first driving characteristic data and the number of pieces of second driving characteristic data” for one autonomous driving kit 90.

The ratio RA may be greater than or equal to the predetermined threshold ratio RAth. In this case, the server SV stores, in the database, the “first information indicating that the vehicle HV is highly likely to enter an intersection with a traffic light when the traffic light is either yellow or red” as the driving characteristic information of the autonomous driving kit 90. On the other hand, in some cases, the ratio RA is less than the threshold ratio RAth for an autonomous driving kit 90. In this case, the server SV stores, in the database, the “second information indicating that the vehicle HV is highly likely to enter an intersection with a traffic light when the traffic light is green” as the driving characteristic information of the autonomous driving kit 90.

### Change of Collision Determination Condition

When an appropriate time comes, the CPU starts the process from S550 of FIG. 5 and proceeds to S555 where it determines whether the vehicle HV is approaching an intersection with a traffic light based on the map information and the current location of the vehicle HV. For example, the CPU determines that the vehicle HV is approaching an intersection with a traffic light, when the distance between the vehicle HV and the intersection with the traffic light is decreasing and is within a predetermined distance.

When the vehicle HV is not approaching an intersection with a traffic light, the CPU proceeds from S555 to S585 described below. On the other hand, when the vehicle HV is approaching an intersection with a traffic light, the CPU proceeds from S555 to S560, and acquires from the server SV the driving characteristic information of the autonomous driving kit 90 mounted on the vehicle HV by communication. More specifically, the CPU transmits, to the server SV, an identifier of the autonomous driving kit 90 mounted on the vehicle HV, an identifier of the vehicle HV, and a download request of the driving characteristic information. The server SV transmits the driving characteristic information stored for each transmitted identifier of the autonomous driving kit 90 to the “vehicle HV having the identifier for which the download request has been made”. The CPU acquires the driving characteristic information transmitted through the communication device 40. The driving characteristic information includes first information and second information. The first information indicates that the vehicle HV is highly likely to enter an intersection with a traffic light when the traffic light is either yellow or red. The second information indicates that the vehicle HV is highly likely to enter an intersection with a traffic light when the traffic light is green.

Next, the CPU proceeds to S565 and determines whether the acquired driving characteristic information is the first information. That is, the CPU determines whether the acquired driving characteristic information is “information indicating that the vehicle HV is highly likely to enter an intersection with a traffic light when the traffic light is either yellow or red”. When the driving characteristic information is the first information, the CPU proceeds to S570 and changes the collision determination condition from the normal condition to the easy-to-meet condition. Next, the CPU proceeds to S575 and notifies the autonomous driving kit 90 that the collision determination condition has been changed. The autonomous driving kit 90 stores the number of times that the collision determination condition is changed. This information is referred to later in the refinement of the autonomous driving kit 90. The CPU then proceeds to S585.

On the other hand, when the driving characteristic information is not the first information (that is, when the driving characteristic information is the second information), the CPU proceeds from S565 to S580, and sets the collision determination condition to the normal condition. The CPU then proceeds to S585.

In S585, the CPU determines whether the current time is immediately after the vehicle HV passed through the intersection with the traffic light, based on the map information and the current location of the vehicle HV.

When the current time is immediately after the vehicle HV passed through the “intersection where the traffic light is installed”, the CPU proceeds from S585 to S590, and sets the collision determination condition to the normal condition regardless of whether the collision determination condition is the easy-to-meet condition or the normal condition. The CPU then proceeds to S595 and tentatively terminates the routine. When the current time is not immediately after the vehicle HV passed through the “intersection where the traffic light is installed”, the CPU proceeds directly from S585 to S595.

As described above, the second device changes the collision determination condition from the normal condition to the easy-to-meet condition when the information indicating that the vehicle HV is highly likely to enter an intersection with a traffic light when the traffic light ahead of the vehicle HV is either yellow or red (i.e., the first information) is acquired from the server SV. Therefore, the second device can further improve the safety of the vehicle HV when the vehicle HV passes through an intersection with a traffic light.

The present disclosure is not limited to the above embodiment, and various modifications can be adopted within the scope of the present disclosure. For example, a device having both the functions of the first device DS and the functions of the second device may be mounted on the vehicle HV. The first device DS is also applicable to a vehicle that does not include the autonomous driving kit 90 (i.e., a normal vehicle in which the driver drives the vehicle). In this instance, in S420 of FIG. 4, the CPU of the vehicle control ECU 10 may perform, as the collision avoidance assist operation, an operation of causing the warning display device to display the warning image instead of automatic braking or in addition to automatic braking. Further, in S420 of FIG. 4, the CPU of the vehicle control ECU 10 may perform, as the collision-avoidance assist operation, an operation of displaying a warning image on the warning display device and/or an operation of generating a warning sound on the warning sound generation device instead of automatic braking or in addition to automatic braking.

Furthermore, the second device can be applied to individual drivers or vehicles instead of the autonomous driving kit 90. More specifically, the CPU transmits the identifier of the driver or the identifier of the vehicle to the server SV instead of the identifier of the autonomous driving kit 90 included in the driving characteristic data in S520 and S525. The server SV is configured to accumulate driving characteristic data for each driver or for each vehicle and to acquire the driving characteristic information. The CPU receives, in S560, driving characteristic information of the driver or the vehicle from the server SV.

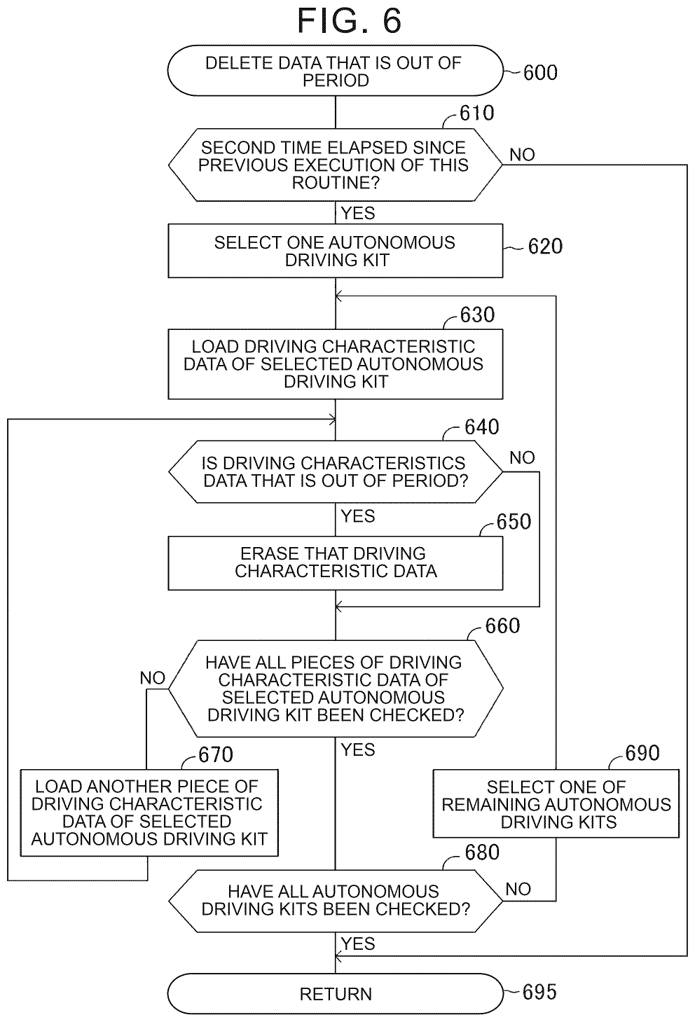

The server SV may execute the routine shown in FIG. 6 every time a first time elapses. More specifically, the server SV starts the process from S600 and proceeds to S610 to determine whether a “second time longer than the first time” has elapsed since the previous execution of this routine.

When the second time has not elapsed since the previous execution of this routine, the server SV proceeds directly from S610 to S695 and tentatively terminates this routine. On the other hand, when the second time has elapsed since the previous execution of this routine, the server SV proceeds to S620 and selects one autonomous driving kit 90 having a certain identifier. The server SV then proceeds to S630 and reads the driving characteristic data of the selected autonomous driving kit 90 from the database.

Next, the server SV proceeds to S640, and determines whether the read driving characteristic data is data for a period that is a predetermined time or more before the current time (namely, data that is out of the period). When the read driving characteristic data is data that is out of the period, the server SV proceeds to S650 and erases the driving characteristic data, and then proceeds to S660. On the other hand, when the read driving characteristic data is not data that is out of the period, the server SV proceeds directly from S640 to S660.

In S660, the server SV determines whether all the pieces of driving characteristic data of the selected autonomous driving kit 90 have been checked. When not all the pieces of driving characteristic data have been checked, the server SV proceeds to S670 and loads another piece of operating characteristic data of the selected autonomous driving kit. The server SV then returns to S640.

On the other hand, when all of the pieces of the driving characteristic data of the selected autonomous driving kit 90 have been checked, the server SV proceeds from S660 to S680, and determines whether all of the autonomous driving kits have been checked. When all autonomous driving kits have not been checked, the server SV proceeds from S680 to S690, selects one of the unchecked autonomous driving kits, and then returns to S630. On the other hand, when all autonomous driving kits have been checked, the server SV proceeds from S680 to S695.

According to this configuration, when the old driving characteristic data is currently no longer valid due to a change in traffic environment, the old driving characteristic data is erased. Alternatively, when the first and second driving characteristic data do not include the version of software for the autonomous driving kit 90, the driving characteristic data for the old version (i.e., the version before the update) is erased. Therefore, the server SV can obtain more accurate driving characteristic information, and can provide the accurate driving characteristic information to the vehicle HV.

What is claimed is:

1. A vehicle control device including a controller configured to perform assist control for avoiding a collision between a vehicle and an object when the vehicle and the object meet a collision determination condition, wherein the controller is configured to
change the collision determination condition from a normal condition to an easy-to-meet condition when the vehicle has entered an intersection with a traffic light while the traffic light ahead of the vehicle is either yellow or red, or when information is acquired that indicates that the vehicle is highly likely to enter an intersection with a traffic light when the traffic light ahead of the vehicle is either yellow or red, the easy-to-meet condition being a condition that is more easily met than the normal condition.

2. The vehicle control device according to claim 1, wherein the controller is configured to autonomously drive the vehicle according to an instruction from an autonomous driving kit mounted on the vehicle.

3. The vehicle control device according to claim 2, wherein the controller is configured to
transmit first driving characteristic data to an external device when the vehicle has entered an intersection with a traffic light while the traffic light ahead of the vehicle is either yellow or red, and
transmit second driving characteristic data to the external device when the vehicle has entered an intersection with a traffic light while the traffic light ahead of the vehicle is green.

4. The vehicle control device according to claim 3, wherein:
the controller is configured to acquire driving characteristic information from the external device by communication, the driving characteristic information being information acquired by the external device based on the first driving characteristic data and the second driving characteristic data and indicating a driving characteristic of the autonomous driving kit; and
the driving characteristic information includes first information and second information, the first information being information indicating that the vehicle is highly likely to enter an intersection with a traffic light when the traffic light is either yellow or red, and the second information being information indicating that the vehicle is highly likely to enter an intersection with a traffic light when the traffic light is green.

5. An external device configured to transmit and receive information to and from a controller configured to autonomously drive a vehicle based on an instruction from an autonomous driving kit, wherein the external device is configured to
receive first driving characteristic data and second driving characteristic data from the controller of the vehicle, the first driving characteristic data being data indicating that the vehicle has entered an intersection with a traffic light while the traffic light ahead of the vehicle is either yellow or red, and the second driving characteristic data being data indicating that the vehicle has entered an intersection with a traffic light while the traffic light ahead of the vehicle is green,
generate driving characteristic information based on the first driving characteristic data and the second driving characteristic data, the driving characteristic information being information indicating a driving characteristic of the autonomous driving kit and including first information and second information, the first information being information indicating that the vehicle is highly likely to enter an intersection with a traffic light when the traffic light is either yellow or red, and the second information being information indicating that the vehicle is unlikely to enter an intersection with a traffic light when the traffic light is either yellow or red, and
transmit the driving characteristic information to the controller or a controller of another vehicle that is autonomously driven by the autonomous driving kit.
